(19) United States
(12) Patent Application Publication
(10) Pub. No.: US 2003/0155239 A1
(43) Pub. Date: Aug. 21, 2003

(54) Sensor element with catalytically active layer and method for the production thereof

(76) Inventors: Roland Stahl, Freiberg (DE); Gerhard Hoetzel, Stuttgart (DE); Harald Neumann, Oberriexingen (DE); Johann Riegel, Bietigheim-Bissingen (DE); Lothar Diehl, Gerlingen (DE)

Correspondence Address: KENYON & KENYON, ONE BROADWAY, NEW YORK, NY, 10004, US

(21) Appl. No.: 10/239,549

(22) PCT Filed: Mar. 15, 2001
(86) PCT No.: PCT/DE01/00972

(30) Foreign Application Priority Data
Mar. 21, 2000 (DE) 10013881.0

(51) Int. Cl. G01N 27/26

(52) U.S. Cl. 204/424; 204/432; 29/592.1

(57) ABSTRACT

The invention describes a sensor element for determining the concentration of gas components in gas mixtures, in particular in exhaust gases of combustion engines. It includes at least one measured gas space (13) and at least one gas inlet opening (17) through which the gas mixture is conveyable to the measured gas space (13), and at least one diffusion barrier (12) arranged between the gas inlet opening (17) and measured gas space (13). The diffusion barrier (12) includes at least one layer (14, 14a, 14b) of catalytically active material for establishing equilibrium in the gas mixture.

The invention relates to a sensor element having a catalytically active layer for determining the concentration of gas components in gas mixtures, and a method for the manufacture thereof, as defined in the preambles of the independent claims.

### BACKGROUND INFORMATION

Amperometric gas sensors for determining the concentration of gas constituents in the exhaust gases of combustion engines are usually operated according to the so-called limiting current principle. A limiting current situation is achieved, however, only if the electrochemical pump cells present in the gas sensor are capable of pumping out of the gas sensor's measured gas space all of the gas to be measured (e.g. oxygen) that is present in the measured gas. In the case of a gas sensor that pumps off oxygen, this must be guaranteed even with an atmospheric oxygen content of approx. 20 vol %. Since the usual electrochemical pump cells used in gas sensors do not have sufficient pumping performance for this, a diffusion barrier is integrated between the gas inlet opening of the sensor element and the measured gas space that contains the electrochemical pump cells. Because of the gas phase diffusion that occurs at this barrier, a concentration gradient forms there between the external gas mixture and the gas atmosphere of the measured gas space. The result of this is that other gas constituents of the gas mixture are also subject to diffusion, and because of their differing diffusion rates a measured gas atmosphere of modified composition is created in the measured gas space of the sensor element.

This has a disadvantageous effect in particular on the measurement accuracy of lambda probes, since the latter measure greatly divergent lambda values when there is an excess of fuel in the exhaust gas (rich exhaust). The reason for this is that the hydrogen present in a rich exhaust has a very high diffusion rate because of its small molecular diameter, and becomes enriched in the measured gas space of the sensor element. If the exhaust gas is exposed to a catalytically active surface before it enters the gas sensor, oxidizing constituents in the exhaust gas then react with the hydrogen, and the measurement accuracy of the exhaust gas sensors is appreciably improved.

German Patent DE 37 28 289 C1 describes a gas sensor that contains a diffusion barrier having a platinum content of up to 90 wt %. What is disadvantageous here is principally the large quantity of platinum required therefor, which has a negative effect on the manufacturing costs of the gas sensor.

It is the object of the present invention to make it possible, with small quantities of platinum and without modifying the diffusion behavior of conventional diffusion barriers, to establish an equilibrium among the gas components even before they reach the electrochemical pump cell of the sensor element.

### ADVANTAGES OF THE PRESENT INVENTION

The sensor element according to the present invention having the characterizing features of claim 1 has the advantage that gas constituents of a gas mixture can be determined very accurately even with rich combustion mixture settings, despite the oxygen deficiency associated therewith. This is achieved by incorporating, in the region of the diffusion barrier, a catalytically active layer that can be produced with little manufacturing outlay in accordance with the method according to the present invention.

The features set forth in the dependent claims make possible additional advantageous developments of and improvements to the sensor element recited in the principal claim. For example, the application of a catalytically active layer on a side of the diffusion barrier facing toward the gas inlet opening of the sensor element allows the gas constituents to react catalytically with one another even before they enter the diffusion barrier.

It is particularly advantageous if a catalytically active layer is incorporated between the diffusion barrier and the solid electrolyte layers surrounding it, since these catalytically active layers make possible good precatalysis and can be produced very easily during manufacture of the sensor element.

### DRAWING

Two exemplified embodiments of the invention are depicted in the drawings and explained in more detail in the description which follows.

FIG. 1 is a cross section through the large surface of the sensor element according to the present invention according to a first embodiment, and

FIG. 2 is a cross section through a sensor element according to a second exemplified embodiment.

### EXEMPLARY EMBODIMENTS

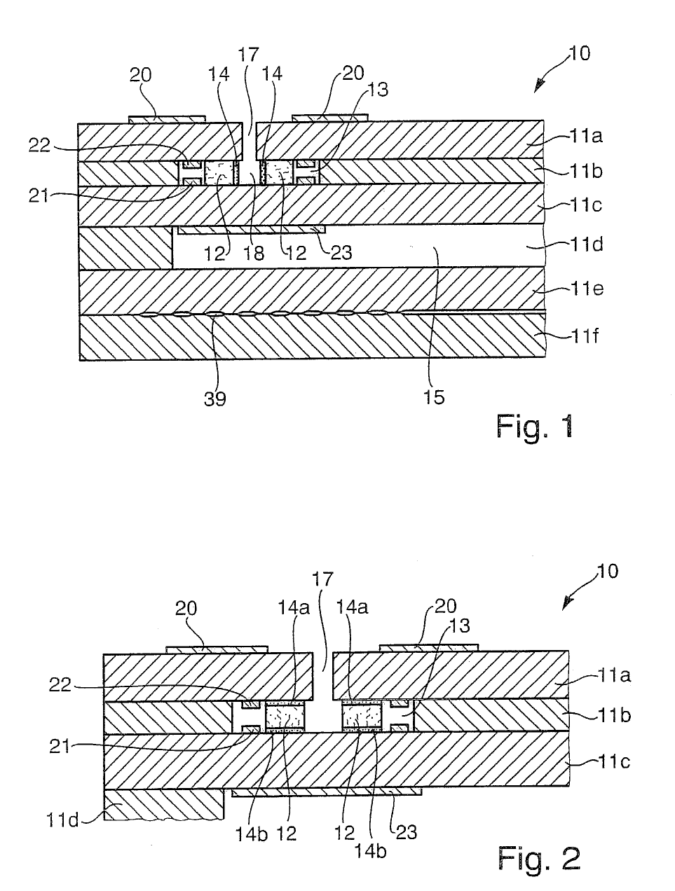

FIG. 1 schematically shows the construction of a first embodiment of the present invention. The number 10 designates a planar sensor element of an electrochemical gas sensor which has, for example, a plurality of oxygen-ion-conducting solid electrolyte layers 11a, 11b, 11c, 11d, 11e, and 11f. Solid electrolyte layers 11a-11f are embodied as ceramic films, and form a planar ceramic body. The integrated form of the planar ceramic body of sensor element 10 is produced in known fashion by laminating together the ceramic films imprinted with functional layers, and then sintering the laminated structure. Each of solid electrolyte layers 11a-11f is made of oxygen-ion-conducting solid electrolyte material, for example ZrO₂ partly or completely stabilized with Y₂O₃.

Sensor element 10 contains a measured gas space 13 and, for example in a further layer level 11d, an air reference conduit 15 that leads out of the planar body of sensor element 10 at one end and communicates with the atmosphere.

Arranged on the large surface of sensor element 10 directly facing the measured gas, on solid electrolyte layer 11a, is an outer pump electrode 20 that can be covered with a porous protective layer (not depicted) and is arranged in annular fashion around a gas inlet opening 17. The associated inner pump electrode 22, which is also embodied in an annular shape matching the annular geometry of measured gas space 13, is located on the side of solid electrolyte layer 11a facing toward measured gas space 13. The two pump electrodes 20, 22 together constitute a pump cell.

Located in measured gas space 13 opposite inner pump electrode 22 is a measurement electrode 21. This is also, for example, embodied in an annular shape. An associated reference electrode 23 is arranged in reference gas conduit 15. The measurement and reference electrodes 21, 23 together constitute a Nernst cell or concentration cell.

To ensure that a thermodynamic equilibrium of the measured gas components is established at the electrodes, all the electrodes used contain a catalytically active material, for example platinum; in a manner known per se, the electrode material for all the electrodes is used as a cermet to permit sintering with the ceramic films.

In addition, a resistance heater 39 is embedded between two electrical insulation layers in the ceramic base body of sensor element 10. The resistance heater serves to heat sensor element 10 to the required operating temperature.

Inside measured gas space 13, a porous diffusion barrier 12 precedes inner pump electrode 22 and measurement electrode 21 in the diffusion direction of the measured gas. Porous diffusion barrier 12 constitutes a diffusion resistance with respect to the gas diffusing toward electrodes 21, 22.

As already mentioned above, a basic prerequisite for the functionality of an amperometric gas sensor is that the electrochemical pump cell of the sensor element always be capable, even at high oxygen concentrations, of removing the entire oxygen content from measured gas space 13. The maximum oxygen content occurring in this context is that of the atmosphere, approximately 20 vol %. Since this results in an overload of the electrochemical pump cell, however, a diffusion barrier 12 is placed upstream from measured gas space 13 and thus also from inner pump electrode 22, resulting in a reduction in the oxygen content in measured gas space 13 due to gas-phase diffusion.

The other gas constituents occurring in the exhaust gas are also subject to diffusion, however, and the composition of the gas atmosphere present in measured gas space 13 depends on the diffusion rate of the individual gas components. Especially with a rich exhaust, this results in a great enrichment in hydrogen in sensor element 10, and thus in a falsified gas sensor reading. The hydrogen content in the exhaust gas can be decreased, however, if the hydrogen is converted on a catalytically active surface with oxidizing gases such as oxygen and carbon dioxide, thus ensuring that a thermodynamic equilibrium is established among the gas constituents.

To bring about this kind of precatalysis, diffusion barrier 12 is equipped, according to the present invention, with a catalytically active layer 14. In a first exemplified embodiment, the latter is applied on a side of diffusion barrier 12 facing toward gas inlet opening 17. It is porous and has a layer thickness that ensures precatalysis but presents no appreciable diffusion resistance to the incoming gas mixture. Catalytically active region 14 contains as catalytically active components metals such as Pt, Ru, Rh, Pd, Ir, or a mixture thereof.

In order to produce catalytically active layer 14 in a cavity 18 of sensor element 10 preceding diffusion barrier 12, solid electrolyte layer 11b, for example, is equipped with a pressed-on cavity paste in the shape of the later cavity 18. The cavity paste breaks down into gaseous products upon subsequent heat treatment. Cavity pastes of this kind usually contain vitreous carbon for this purpose. If the cavity paste has the catalytically active component mixed into it, either as a powder or in a form deposited onto vitreous carbon, cavity 18 then forms during the heat treatment, and the catalytically active component precipitates onto the walls of cavity 18 and thus forms catalytically active layer 14. The deposition of catalytically active layer 14 is not limited to the side of diffusion barrier 12 facing toward gas inlet opening 17; other surfaces in the region of cavity 18 are also coated. This is entirely desirable.

Deposition of the catalytically active material onto the vitreous carbon can occur either mechanically, by milling the vitreous carbon with a powder of the catalytically active component, or by chemical deposition of the catalytically active components onto the vitreous carbon powder.

It is also possible to perform the precatalysis on a catalytically active layer inside the diffusion barrier. A corresponding second exemplified embodiment of the sensor element according to the present invention is depicted in FIG. 2, which depicts a portion of the sensor element depicted in FIG. 1.

Here a respective catalytically active layer 14a, 14b is arranged, parallel to the flow direction of the gas mixture, between diffusion barrier 12 and each of the surrounding solid electrolyte layer 11a, 11b. The layer thickness of the catalytically active layer is low, so that no substantial change occurs in the diffusion resistance of diffusion barrier 12. Catalytically active layer 14a, 14b contains catalytically active components comparable to those of the first exemplary embodiment.

Manufacture of a sensor element according to the second exemplified embodiment can be accomplished very efficiently. A first catalytically active layer 14a is produced together with inner pump electrode 22 in a single printing operation using an electrode paste, and a second catalytically active layer 14b is produced together with measurement electrode 21. The two catalytically active layers 14a, 14b are manufactured from the same printing paste as the simultaneously printed electrodes 21, 22.

Since the establishment of equilibrium among the gas components is inhibited by sulfur oxides in the exhaust gas, catalytically active layers 14, 14a, 14b furthermore have mixed into them one or more substances that remove sulfur oxides from the incoming exhaust gas. This can be, for example, barium nitrate. It is explicitly to be noted that the utilization of catalytically active layers for precatalysis in exhaust gas sensors is not limited to the exemplified embodiments set forth, but rather can also be used in multi-chamber sensors, sensors having several pump cells and concentration cells, or sensors having an end-located gas inlet opening.

What is claimed is:

1. A sensor element constructed in layer form for determining the concentration of gas components in gas mixtures, in particular in exhaust gases of combustion engines, comprising at least one measured gas space and at least one gas inlet opening through which the gas mixture is conveyable to the measured gas space, and at least one diffusion barrier arranged between the gas inlet opening and measured gas space, the measured gas space and the diffusion barrier being arranged in a layer plane between a first and a second solid electrolyte layer,
wherein the diffusion barrier (12) has at least one layer (14, 14a, 14b) of catalytically active material for establishing equilibrium in the gas mixture.

2. The sensor element as recited in claim 1,
wherein the layer (14) of catalytically active material is formed on a side of the diffusion barrier (12) facing toward the gas inlet opening (17).

3. The sensor element as recited in claim 1,
wherein the layer (14a, 14b) of catalytically active material is formed at least partially on at least one outer surface, facing a solid electrolyte layer (11a, 11b), of the diffusion barrier (12).

4. The sensor element as recited in one of claims 1 through 3,
wherein the catalytically active material contains a metal from the group Pt, Ru, Rh, Pd, Ir, or a mixture thereof.

5. The sensor element as recited in one of claims 1 through 3,
wherein the layer of catalytically active material (14, 14a, 14b) and the diffusion barrier have different porosities.

6. The sensor element as recited in one of the preceding claims, wherein the layer (14, 14a, 14b) of catalytically active material contains a component that removes sulfur oxides from the gas mixture.

7. The sensor element as recited in claim 6,
wherein the component that removes sulfur oxides from the gas mixture is barium nitrate.

8. A method for manufacturing a sensor element as recited in one of claims 1 through 7, for determining gas components in gas mixtures,
wherein a catalytically active material is added to a printing paste; and at least one catalytically active layer (14, 14a, 14b) is produced from the printing paste on a diffusion barrier (12), using a printing operation and a subsequent heat treatment.

9. The method as recited in claim 8,
wherein the catalytically active material is chemically deposited onto vitreous carbon, and the vitreous carbon is added to the printing paste.

10. The method as recited in claim 8,
wherein the catalytically active material is mechanically deposited onto vitreous carbon, and the vitreous carbon is added to the printing paste.

11. The method as recited in one of claims 8 through 10,
wherein the printing paste is introduced into a space preceding the diffusion barrier (12); and by way of a subsequent heat treatment, the catalytically active layer (14) deposits on the diffusion barrier (12), and a cavity (18) is produced in the sensor element while gaseous products of the printing paste are released.

12. The method as recited in one of claims 8 through 10, wherein, using the printing paste, an electrode (21, 22) arranged in the measured gas space (13) and the catalytically active layer (14a, 14b) are printed in one working step in each case, the catalytically active layer (14a, 14b) being produced in an interstice between a solid electrolyte layer (11a, 11b) and the diffusion barrier (12) of the sensor element.
